(19) United States
(12) Patent Application Publication
(10) Pub. No.: US 2024/0220210 A1
(43) Pub. Date: Jul. 4, 2024

(54) MODULO DIVIDER AND MODULO DIVISION OPERATION METHOD FOR BINARY DATA

(71) Applicant: Industrial Technology Research Institute, Hsinchu (TW)

(72) Inventors: Chia-Hsiang Yang, Kinmen County (TW); Liang-Hsin Lin, Yilan County (TW); Yu-Ling Kang, Taoyuan City (TW); Yu-Hui Lin, Hsinchu County (TW); Chih-Ming Lai, Taipei City (TW)

(73) Assignee: Industrial Technology Research Institute, Hsinchu (TW)

(21) Appl. No.: 18/152,170

(22) Filed: Jan. 10, 2023

(30) Foreign Application Priority Data
Jan. 3, 2023 (TW) 112100049

(51) Int. Cl. G06F 7/72; G06F 5/01

(52) U.S. Cl. CPC G06F 7/729; G06F 5/01

(57) ABSTRACT

A modulo divider and a modulo division operation method for binary data are provided, including: converting a first variant and a second variant to a variant set according to a first mapping table; generating a fifth variant and a sixth variant according to the variant set; generating a seventh variant and an eighth variant according to the variant set; updating the first variant according to one of the fifth variant and the sixth variant and updating the second variant according to the other one of the fifth variant and the sixth variant; updating the third variant according to one of the seventh variant and the eighth variant and updating the fourth variant according to the other one of the seventh variant and the eighth variant; and outputting the third variant as a result of a modulo division operation in response to determining the updating of the third variant being finished.

### CROSS-REFERENCE TO RELATED APPLICATION

This application claims the priority benefit of Taiwan application serial no. 112100049 filed on Jan. 3, 2023. The entirety of the above-mentioned patent application is hereby incorporated by reference herein and made a part of this specification.

### TECHNICAL FIELD

The disclosure relates to a technique for calculating binary data, and in particular relates to a modulo divider and a modulo division operation method for binary data.

### BACKGROUND

The vigorous development of the Internet of things (IoT) has led to an increase in the number of wireless devices used. By 2025, it is estimated that 75 billion IoT devices will be used. In order to prevent malicious attacks from the Internet, the hardware security of IoT devices has become an important issue in the field of information security in recent years. Hardware security refers to the ability of physical devices to resist malicious attacks. For example, common wearable devices, smart home systems, or various types of sensors all require hardware security technology to protect data transmission and avoid malicious attacks. The most common way to achieve hardware security is to use hardware devices that implement encryption algorithms, such as cryptographic elements that may be installed on terminal devices to implement encrypted communication protocols, anti-theft serial numbers of physical devices, authentication procedures when starting physical devices (e.g., Ed25519 signature authentication system), low-latency transceivers required for smart self-driving cars, or encryption elements and storage elements required for smart wallets.

However, IoT devices have limited computing resources or power. Therefore, how to provide a high-efficiency computing method for the IoT device to save the computing resources and power consumed by the encryption algorithm implemented by the IoT device is one of the goals for those skilled in the art.

### SUMMARY

The disclosure provides a modulo divider and a modulo division operation method for binary data, which support two operating modes of fixed execution time mode or non-fixed execution time mode. The fixed execution time mode may prevent the device applying the modulo divider from timing attack.

A modulo divider for binary data of the disclosure includes the following components. A first register stores a first variant. A second register stores a second variant. A third register stores a third variant. A fourth register stores a fourth variant. A first logic mapping circuit is coupled to the first register and the second register, and converts the first variant and the second variant to a variant set according to a first mapping table. A second logic mapping circuit is coupled to the first logic mapping circuit, and obtains the variant set based on a first instruction from the first logic mapping circuit. A first calculation circuit is coupled to the first logic mapping circuit, and generates a fifth variant and a sixth variant according to the variant set. A second calculation circuit is coupled to the second logic mapping circuit, and generates a seventh variant and an eighth variant according to the variant set. A first switching circuit is coupled to the first calculation circuit, the first register, and the second register, in which the first switching circuit updates the first variant according to one of the fifth variant and the sixth variant, and updates the second variant according to the other one of the fifth variant and the sixth variant. A second switching circuit is coupled to the second calculation circuit, the third register, the fourth register, and the first switching circuit, in which the second switching circuit updates the third variant according to one of the seventh variant and the eighth variant based on a second instruction from the first switching circuit, and updates the fourth variant according to the other one of the seventh variant and the eighth variant. A processor is coupled to the second register, in which the processor determines whether the updating of the third variant is finished, and outputs the third variant as a result of the modulo division operation in response to determining the updating of the third variant is finished.

In an embodiment of the disclosure, the first calculation circuit includes the following components. A first multiplier is coupled to the first register and the first logic mapping circuit, and outputs a first product of the first variant and a first value in the variant set. A second multiplier is coupled to the second register and the first logic mapping circuit, and outputs a second product of the second variant and a second value in the variant set. A first adder is coupled to the first multiplier and the second multiplier, and calculates a first sum of the first product and the second product. A first shifter is coupled to the first adder and the first switching circuit, and shifts the first sum to generate the fifth variant.

In an embodiment of the disclosure, the first calculation circuit further includes the following components. A third multiplier is coupled to the first register and the first logic mapping circuit, and outputs a third product of the first variant and a third value in the variant set. A fourth multiplier is coupled to the second register and the first logic mapping circuit, and outputs a fourth product of the second variant and a fourth value in the variant set. A second adder is coupled to the third multiplier and the fourth multiplier, and calculates a second sum of the third product and the fourth product. A second shifter is coupled to the second adder and the first switching circuit, and shifts the second sum to generate the sixth variant.

In an embodiment of the disclosure, the first mapping table includes a mapping relationship between the first variant, the second variant, and the variant set, in which the mapping relationship satisfies the following conditions:

$$\{ \begin{matrix}( {l}_{1} f + {l}_{2} g ) mod {2}^{m} = 0 \\ ( {l}_{3} f + {l}_{4} g ) mod {2}^{m} = 0 \\ {l}_{1} f + {l}_{2} g > 0 \\ {l}_{3} f + {l}_{4} g > 0 \\ {l}_{1} {l}_{4} - {l}_{2} {l}_{3} = \pm {2}^{m} \\ \frac{( {l}_{1} f + {l}_{2} g ) \times ( {l}_{3} f + {l}_{4} g )}{{2}^{{2}^{m}}} \leq \frac{fg}{{2}^{m}}\end{matrix}$$

Where f is the first variant, g is the second variant, l₁ is the first value in the variant set, l₂ is the second value in the variant set, l₃ is the third value in the variant set, l₄ is the fourth value in the variant set, and m is a positive integer.

In an embodiment of the disclosure, the second calculation circuit includes the following components. A fifth multiplier is coupled to the third register and the second logic mapping circuit, and outputs a fifth product of the third variant and the first value in the variant set. A sixth multiplier is coupled to the fourth register and the second logic mapping circuit, and outputs a sixth product of the fourth variant and the second value in the variant set. A third adder is coupled to the fifth multiplier and the sixth multiplier, and calculates a third sum of the fifth product and the sixth product. A third shifter is coupled to the third adder, and shifts the third sum. A lookup table circuit is coupled to the third adder, and generates a first lookup value corresponding to the third sum according to the lookup table. A fourth adder is coupled to the third shifter and the lookup table circuit, and calculates a fourth sum of the shifted third sum and the first lookup value. A first modulo divider is coupled to the fourth adder, and modulo-divides the fourth sum by an initial value of the first variant to generate the seventh variant.

In an embodiment of the disclosure, the second calculation circuit further includes the following components. A seventh multiplier is coupled to the third register and the second logic mapping circuit, and outputs a seventh product of the third variant and the third value in the variant set. An eighth multiplier is coupled to the fourth register and the second logic mapping circuit, and outputs an eighth product of the fourth variant and the fourth value in the variant set. A fifth adder is coupled to the seventh multiplier, the eighth multiplier, and the lookup table circuit, and calculates a fifth sum of the seventh product and the eighth product, in which the lookup table circuit generates a second lookup value corresponding to the fifth sum according to the lookup table. A fourth shifter is coupled to the fifth adder, and shifts the fifth sum. A sixth adder is coupled to the fourth shifter and the lookup table circuit, and calculates a sixth sum of the shifted fifth sum and the second lookup value. A second modulo divider is coupled to the sixth adder, and modulo-divides the sixth sum by the initial value of the first variant to generate the eighth variant.

In an embodiment of the disclosure, in response to the fifth variant being greater than or equal to the sixth variant, the first switching circuit updates the first variant according to the fifth variant and updates the second variant according to the sixth variant.

In an embodiment of the disclosure, in response to the fifth variant being less than the sixth variant, the first switching circuit updates the first variant according to the sixth variant and updates the second variant according to the fifth variant.

In an embodiment of the disclosure, in response to the fifth variant being greater than or equal to the sixth variant, the second switching circuit updates the third variant according to the seventh variant and updates the fourth variant according to the eighth variant.

In an embodiment of the disclosure, in response to the fifth variant being less than the sixth variant, the second switching circuit updates the third variant according to the eighth variant and updates the fourth variant according to the seventh variant.

In an embodiment of the disclosure, the third sum and the first lookup value satisfy the following conditions:

$${LT}_{out} = [ ( - {LT}_{in} \times {p}^{- 1} mod {2}^{m} ) \times p + {LT}_{in} ] >> m$$

Where LTₒᵤₜ is the first lookup value, LTᵢₙ is the third sum, p is the initial value of the first variant, m is a positive integer, and >>m means shifting m bits to the right.

In an embodiment of the disclosure, the processor is configured to execute the following operation. In response to the third variant being updated, a count value is increased. An updating of the third variant being finished is determined in response to the count value reaching a target value, in which the target value is associated with a number of bits of the third variant.

In an embodiment of the disclosure, the processor is configured to execute the following operation. In response to the second variant being updated to zero, the updating of the third variant being finished is determined.

In an embodiment of the disclosure, the modulo of the modulo division operation is the initial value of the first variant, in which the dividend of the modulo division operation is equal to dividing an initial value of the fourth variant by an initial value of the second variant.

In an embodiment of the disclosure, the initial value of the fourth variant and the initial value of the second variant are coprime.

A modulo division operation method for binary data of the disclosure includes the following operation. A first variant, a second variant, a third variant, and a fourth variant are obtained. The first variant and the second variant are converted to a variant set according to a first mapping table. A fifth variant and a sixth variant are generated according to the variant set. A seventh variant and an eighth variant are generated according to the variant set. The first variant is updated according to one of the fifth variant and the sixth variant, and the second variant is updated according to the other one of the fifth variant and the sixth variant. The third variant is updated according to one of the seventh variant and the eighth variant, and the fourth variant is updated according to the other one of the seventh variant and the eighth variant. Whether an updating of the third variant being finished is determined, and the third variant is output as a result of the modulo division operation in response to determining that the updating of the third variant is finished.

Based on the above, the modulo divider of the disclosure has two modes: a fixed execution time mode and a non-fixed execution time mode. In the fixed execution time mode, the modulo divider may finish the modulo division operation within a fixed time, so as to prevent the device using the modulo divider from timing attack. In the non-fixed execution time mode, the modulo divider may calculate the result of the modulo division operation in the shortest time. Compared with the conventional modulo divider, the modulo divider of the disclosure may finish the modulo division operation of binary data with a high number of bits in a shorter time.

### BRIEF DESCRIPTION OF DRAWINGS

FIG. 1 is a schematic diagram of a modulo divider for binary data according to an embodiment of the disclosure.

FIG. 2 is a flowchart of a modulo division operation performed by using a modulo divider according to an embodiment of the disclosure.

FIG. 3 is a flowchart of a modulo division operation method for binary data according to an embodiment of the disclosure.

### DETAILED DESCRIPTION OF DISCLOSED EMBODIMENTS

In order to make the content of the disclosure easier to understand, the following specific embodiments are illustrated as examples of the actual implementation of the disclosure. In addition, wherever possible, elements/components/steps with the same reference numerals in the drawings and embodiments represent the same or similar parts.

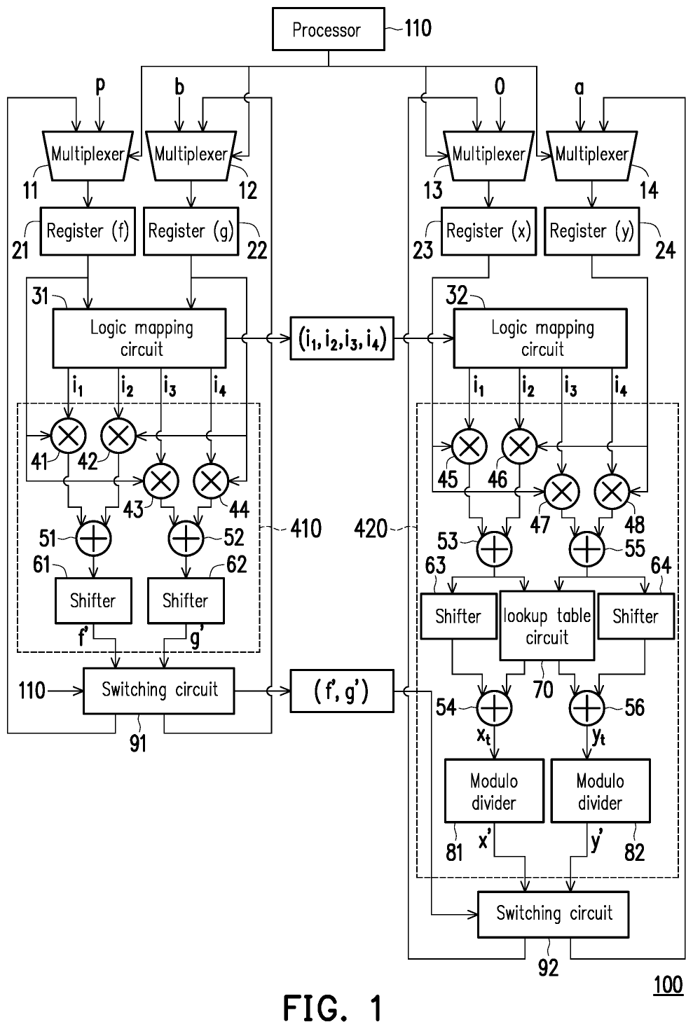

FIG. 1 is a schematic diagram of a modulo divider 100 for binary data according to an embodiment of the disclosure. The modulo divider 100 may be used to generate the result of the modulo division operation [(a/b) mod p], where a or b is an integer represented in binary n-bits, and p is a prime number represented in binary n-bits, where p>2, where a and b are coprime.

The circuit of the modulo divider 100 may comprise a processor 110, a multiplexer 11, a multiplexer 12, a multiplexer 13, a multiplexer 14, a register 21, a register 22, a register 23, a register 24, a logic mapping circuit 31, a logic mapping circuit 32, a calculation circuit 410, a calculation circuit 420, a switching circuit 91, and a switching circuit 92. The register 21, the register 22, the register 23, or the register 24 includes but is not limited to a D-type flip-flop.

The processor 110 is coupled to the multiplexer 11, the multiplexer 12, the multiplexer 13, and the multiplexer 14, and selects output data for each multiplexer. The processor 110 is also coupled to the register 22 (the lines between the processor 110 and the register 22 are not shown in FIG. 1). The register 21 may be coupled to the multiplexer 11 and the logic mapping circuit 31 and may store a variant f, in which the initial value of the variant f may be p. The register 22 may be coupled to the multiplexer 12 and the logic mapping circuit 31 and may store a variant g, in which the initial value of the variant g may be b. The register 23 may be coupled to the multiplexer 13 and the calculation circuit 420 and may store a variant x, in which the initial value of the variant x may be zero. The register 24 may be coupled to the multiplexer 14 and the calculation circuit 420 and may store a variant y, in which the initial value of the variant y may be a. That is to say, modulo p of the modulo division operation may be the initial value of the variant f, and the dividend (a/b) of the modulo division operation may be the initial value of the variant y divided by the initial value of the variant g, where the initial value of the variant y and the initial value of the variant g are coprime (i.e., a and b are coprime).

The logic mapping circuit 31 may be coupled to the calculation circuit 410 and the logic mapping circuit 32. The calculation circuit 410 may be coupled to the switching circuit 91. The switching circuit 91 may be coupled to the multiplexer 11 and the multiplexer 12. The logic mapping circuit 32 may be coupled to the calculation circuit 420 and the logic mapping circuit 31. The calculation circuit 420 may be coupled to the switching circuit 92. The switching circuit 92 may be coupled to the multiplexer 13, the multiplexer 14, and the switching circuit 91.

The calculation circuit 410 may include a multiplier 41 coupled to the register 21 and the logic mapping circuit 31, a multiplier 42 coupled to the register 22 and the logic mapping circuit 31, a multiplier 43 coupled to the register 21 and the logic mapping circuit 31, and a multiplier 44 coupled to the register 22 and the logic mapping circuit 31. The calculation circuit 410 further includes an adder 51 coupled to multiplier 41 and multiplier 42, an adder 52 coupled to multiplier 43 and multiplier 44, a shifter 61 coupled to the adder 51, and a shifter 62 coupled to the adder 52. The shifter 61 and the shifter 62 may be respectively coupled to the switching circuit 91.

The calculation circuit 420 may include a multiplier 45 coupled to the register 23 and the logic mapping circuit 32, a multiplier 46 coupled to the register 24 and the logic mapping circuit 32, a multiplier 47 coupled to the register 23 and the logic mapping circuit 32, and a multiplier 48 coupled to the register 24 and the logic mapping circuit 32. The calculation circuit 420 further includes an adder 53 coupled to the multiplier 45 and the multiplier 46, and an adder 55 coupled to the multiplier 47 and the multiplier 48.

The calculation circuit 420 further includes a shifter 63 coupled to the adder 53, a shifter 64 coupled to the adder 55, a lookup table circuit 70 coupled to the adder 53 and the adder 55, an adder 54 coupled to the shifter 63 and the lookup table circuit 70, an adder 56 coupled to the shifter 64 and the lookup table circuit 70, a modulo divider 81 coupled to the adder 54, and a modulo divider 82 coupled to the adder 56. The modulo divider 81 and the modulo divider 82 may be respectively coupled to the switching circuit 92.

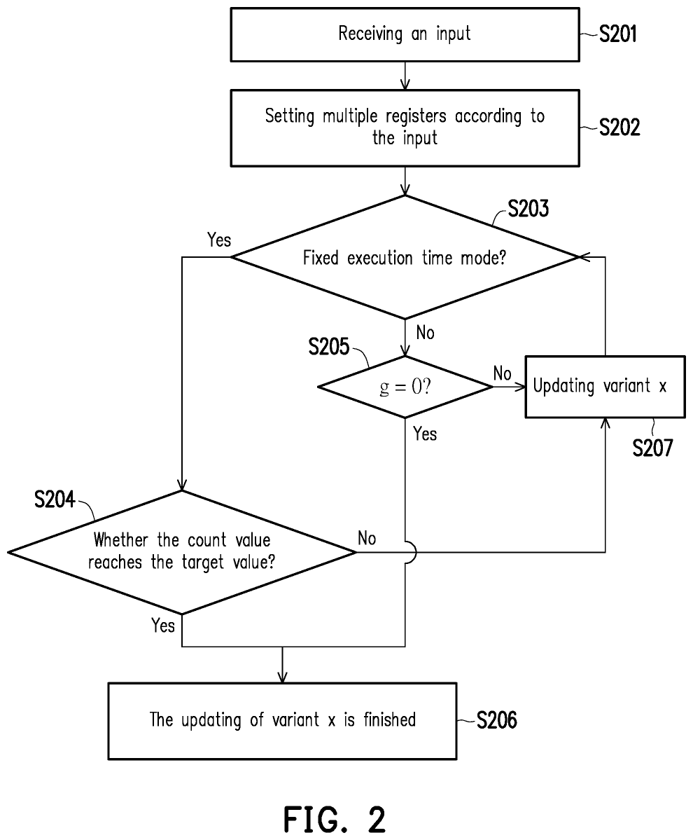

FIG. 2 is a flowchart of a modulo division operation performed by using a modulo divider 100 according to an embodiment of the disclosure. In step S201, the modulo divider 100 may receive an input, in which the input may include a variant a, a variant b, and a variant p. In addition, the input may further include an operation mode of the modulo divider 100, in which the operation mode instructs one of the fixed execution time mode and the non-fixed execution time mode. The modulo divider 100 may be used to generate the result of the modulo division operation [(a/b) mod p].

In step S202, the processor 110 may set multiple registers (i.e., the register 21, the register 22, the register 23, and the register 24) according to the input, and may set an initial value of a count value to zero. Specifically, the processor 110 may control the multiplexer 11 so that the variant p input to the multiplexer 11 (i.e., modulo p of the modulo operation) is transmitted to the register 21 as an initial value of the variant f. The processor 110 may control the multiplexer 12 so that the variant b input to the multiplexer 12 is transmitted to the register 22 as an initial value of the variant g. The processor 110 may control the multiplexer 13 so that the value 0 input to the multiplexer 13 is transmitted to the register 23 as an initial value of the variant x. The processor 110 may control the multiplexer 14 so that the variant a input to the multiplexer 14 is transmitted to the register 24 as an initial value of the variant y. It should be noted that the number of bits of the variant f, the variant g, the variant x, and the variant y must be the same. In other words, the variant p, the variant a, and the variant b must have the same number of bits. In this embodiment, it is assumed that the number of bits of the variant f, the variant g, the variant x, and the variant y (or the variant p, the variant a, and the variant b) is n, where n is a positive integer. For example, if n=256, it means that the modulo divider 100 performs a 256-bit modulo division operation.

In step S203, the processor 110 may determine whether the operation mode of the modulo divider 100 is a fixed execution time mode according to the input in step S201. If the processor 110 determines that the operation mode of the modulo divider 100 is the fixed execution time mode, then enter step S204. If the processor 110 determines that the operation mode of the modulo divider 100 is the non-fixed execution time mode, then enter step S205.

In step S204, the processor 110 may determine whether the count value reaches a target value, in which the target value is associated with the number of bits n of the variant (i.e., the variant f, g, x, or y). If the processor 110 determines that the count value reaches the target value, then enter step S206. If the processor 110 determines that the count value has not reached the target value, then enter step S207. In one embodiment, the target value may be [(n/m)+1], where m is the number of bits that may be calculated in each iteration of step S207, and m is a positive integer. In the fixed execution time mode, the modulo divider 100 may finish the modulo division operation within [(n/m)+1] clock cycles.

In step S205, the processor 110 may determine whether the variant g in the register 22 has been updated to zero. If the processor 110 determines that the variant g has been updated to zero, then enter step S206. If the processor 110 determines that the variant g has not been updated to zero, then enter step S207. In the non-fixed execution time mode, the modulo divider 100 may operate until the variant g is updated to zero. The modulo divider 100 may finish the 256-bit modulo division operation within 180 clock cycles on average.

In step S206, the processor 110 may determine that the updating of the variant x is finished. The processor 110 may output the updated variant x as a result of the modulo division operation.

In step S207, the processor 110 may update the variant x. In one embodiment, the processor 110 may control the multiplexer 11 and the multiplexer 12 so that the two output values of the switching circuit 91 are respectively transmitted to the register 21 and the register 22, and may control the multiplexer 13 and the multiplexer 14 so that the two output values of the switching circuit 92 are respectively transmitted to the register 23 and the register 24, so as to update the variant x. If the operation mode of the modulo divider 100 is a fixed execution time mode, the processor 110 may add one to the count value after the variant x is updated. For example, the processor 110 may be coupled to the register 23 to detect whether the variant x in the register 23 is changed. If the processor 110 detects that the variant x changes, the processor 110 may increase the count value by one.

The updating method of the variant x is specifically described as follows. First, the logic mapping circuit 31 may respectively receive the variant f and the variant g from the register 21 and the register 22. The logic mapping circuit 31 may convert the variant f and the variant g into a variant set (l₁, l₂, l₃, l₄) according to the logic mapping table stored in the logic mapping circuit 31. Specifically, the logic mapping table in the logic mapping circuit 31 may include the mapping relationship between the variant f and the variant g and the variant set (l₁, l₂, l₃, l₄), where the mapping relationship satisfies the conditions shown in Equation (1), wherein f is a variant from the register 11, g is a variant from the register 12, l₁ is a value input to the multiplier 41, l₂ is a value input to the multiplier 42, l₃ is a value input to the multiplier 43, l₄ is a value input to the multiplier 44, and m is the number of bits that may be calculated in each iteration of step S207.

$$\{ \begin{matrix}( {l}_{1} f + {l}_{2} g ) mod {2}^{m} = 0 \\ ( {l}_{3} f + {l}_{4} g ) mod {2}^{m} = 0 \\ {l}_{1} f + {l}_{2} g > 0 \\ {l}_{3} f + {l}_{4} g > 0 \\ {l}_{1} {l}_{4} - {l}_{2} {l}_{3} = \pm {2}^{m} \\ \frac{( {l}_{1} f + {l}_{2} g ) \times ( {l}_{3} f + {l}_{4} g )}{{2}^{{2}^{m}}} \leq \frac{fg}{{2}^{m}}\end{matrix} \qquad Equation ( 1 )$$

Table 1 is an example of the logic mapping table in the logic mapping circuit 31 when modulo p is equal to 4, where “s” means the interval to which the quotient of f divided by g belongs. For example, assuming that the variant p is equal to 4, if the result of variant f modulo 4 is 0, the result of variant g modulo 4 is 1, and the quotient of variant f divided by variant g belongs to the interval [1, ∞], then the logic mapping circuit 31 may generate a variant set (l₁, l₂, l₃, l₄)=(1,0,0,4) according to Table 1.

TABLE 1

| (f mod 4, g mod 4, s) | (1₁, 1₂, 1₃, 1₄) |
|---|---|
| (0, 1, [1, ∞]) or (0, 3, [1, ∞)) | (1, 0, 0, 4) |
| (1, 0, [1, ∞]) or (3, 0, [1, ∞)) | (4, 0, 0, 1) |
| (1, 1, [1, ∞]) | (1, −1, 0, 4) |
| (1, 3, [1, 3)) or (3, 1, [1, 3)) | (2, −2, −1, 3) |
| (1, 3, [3, ∞)) or (3, 1, [3, ∞)) | (1, −3, 0, 4) |
| (2, 1, [1, 2)) or (2, 3, [1, 2)) | (2, 0, −1, 2) |
| (2, 1, [2, ∞)) or (2, 3, [2, ∞)) | (1, −2, 0, 4) |
| (1, 2, [1, ∞)) or (3, 2, [1, ∞)) | (2, −1, 0, 2) |

After obtaining the variant set (l₁, l₂, l₃, l₄)), the logic mapping circuit 31 may transmit an instruction including the variant set (l₁, l₂, l₃, l₄) to the logic mapping circuit 32. The logic mapping circuit 32 may receive the instruction to obtain the variant set (l₁, l₂, l₃, l₄) based on the instruction.

The calculation circuit 410 may generate a variant f′ and a variant g′ according to the variant set (l₁, l₂, l₃, l₄). Specifically, the logic mapping circuit 31 may respectively transmit the value l₁, the value l₂, the value l₃, and the value l₄ in the variant set (l₁, l₂, l₃, l₄) to the multiplier 41, the multiplier 42, the multiplier 43, and the multiplier 44. The multiplier 41 may calculate and output the product l₁f of the variant f and the value l₁, and the multiplier 42 may calculate and output the product l₂g of the variant g and the value l₂. The adder 51 may calculate the sum l₁f+l₂g of the product l₁f and the product l₂g. The shifter 61 may be used as a divider for binary data. The shifter 61 may shift the sum l₁f+l₂g to the right by m bits (i.e., divide the sum l₁f+l₂g by 2^{m}) to generate the variant f′=(l₁f+l₂g)/2^{m}. The multiplier 43 may calculate and output the product l₃f of the variant f and the value l₃, and the multiplier 44 may calculate and output the product l₄g of the variant g and the value l₄. The adder 52 may calculate the sum l₃f+l₄g of the product l₃f and the product l₄g. The shifter 62 may be used as a divider for binary data. The shifter 62 may shift the sum l₃f+l₄g to the right by m bits (i.e., divide the sum l₃f+l₄g by 2^{m}) to generate the variant g′=(l₃f+l₄g)/2^{m}.

The switching circuit 91 may respectively receive the variant f′ and the variant g′ from the shifter 61 and the shifter 62. Then, the switching circuit 91 may update the variant f in the register 21 according to one of the variant f′ and the variant g′, and update the variant g in the register 22 according to the other one of the variant f′ and the variant g′. Specifically, the switching circuit 91 may compare the variant f′ and the variant g′. If f≥g′, the switching circuit 91 may transmit the variant f′ to the multiplexer 11. The processor 110 may control the multiplexer 11 to transmit the variant f′ to the register 21 to update the variant f in the register 21. In addition, the switching circuit 91 may transmit the variant g′ to the multiplexer 12. The processor 110 may control the multiplexer 12 to transmit the variant g′ to the register 22 to update the variant g in the register 22. If f′<g′, the switching circuit 91 may transmit the variant g′ to the multiplexer 11. The processor 110 may control the multiplexer 11 to transmit the variant g′ to the register 21 to update the variant f in the register 21. In addition, the switching circuit 91 may transmit the variant f′ to the multiplexer 12. The processor 110 may control the multiplexer 12 to transmit the variant f′ to the register 22 to update the variant g in the register 22.

On the other hand, the calculation circuit 420 may generate the variant x′ and the variant y′ according to the variant set (l₁, l₂, l₃, l₄). Specifically, the logic mapping circuit 32 may transmit the value l₁, the value l₂, the value l₃ and the value l₄ in the variant set (l₁, l₂, l₃, l₄) to the multiplier 45, the multiplier 46, the multiplier 47, and the multiplier respectively device 48. The multiplier 45 may calculate and output the product l₁x of the variant x and the value l₁, and the multiplier 46 may calculate and output the product l₂y of the variant y and the value l₂. The adder 53 may calculate the sum l₁x+l₂y of the product l₁x and the product l₂y. The lookup table circuit 70 may generate the lookup value LTₒᵤₜ corresponding to the input LTᵢₙ (i.e., the sum l₁x+12y) according to the lookup table stored in the lookup table circuit 70. The lookup value LTₒᵤₜ may satisfy the conditions shown in Equation (2), where p is the initial value of the variant f (i.e., the modulo of the modulo division operation), m is a positive integer, and >>m means shifting m bits to the right. The size of the lookup table may be 2^{m}×n bits.

$${LT}_{out} = [ ( - {LT}_{in} \times {p}^{- 1} mod {2}^{m} ) \times p + {LT}_{in} ] >> m \qquad Equation ( 2 )$$

The shifter 63 may shift the sum l₁x+l₂y to the right by m bits (i.e., divide the sum l₁x+l₂y by 2^{m}) to generate a variant (l₁x+l₂y)/2^{m}. The adder 54 may generate the variant (l₁x+l₂y)/2^{m} and the sum xₜ corresponding to the lookup value LTₒᵤₜ of the sum l₁x+l₂y, as shown by the Montgomery algorithm in Equation (3). The modulo divider 81 may modulo divide the sum xₜ by the initial value of the variant f (i.e., modulo p) to generate the variant x′, as shown in Equation (4). Appropriate mapping relationship between the variant f and the variant g and the variant set (l₁, l₂, l₃, l₄) may reduce the number of possible

$$⌊ \frac{{x}_{t}}{p} ⌋ .$$

Therefore, the modulo divider 81 may also be replaced by a simple comparator.

$$\begin{matrix}{x}_{t} = \frac{{l}_{1} x + {l}_{2} y + ( - ( {l}_{1} x + {l}_{2} y ) mod {2}^{m} ) p}{{2}^{m}} & Equation ( 3 ) \\ {x}^{′} = {x}_{t} - ⌊ \frac{{x}_{t}}{p} ⌋ p & Equation ( 4 )\end{matrix}$$

The multiplier 47 may calculate and output the product l₃x of the variant x and the value l₃, and the multiplier 48 may calculate and output the product l₄y of the variant y and the value l₄. The adder 55 may calculate the sum l₃x+l₄y of the product l₃x and the product l₄y. The lookup table circuit 70 may generate the lookup value LTₒᵤₜ corresponding to the input LTᵢₙ(i.e., the sum l₃x+l₄y) according to the lookup table stored in the lookup table circuit 70. The lookup value LTₒᵤₜ may satisfy the condition shown in Equation (2).

The shifter 64 may shift the sum l₃x+l₄y to the right by m bits (i.e., divide the sum l₃x+l₄y by 2^{m}) to generate a variant (l₃x+l₄y)/2^{m}. The adder 56 may generate the variant (l₃x+l₄y)/2^{m} and the sum yₜ corresponding to the lookup value LTₒᵤₜ of the sum l₃x+l₄y, as shown by the Montgomery algorithm in Equation (5). The modulo divider 82 may modulo divide the sum yₜ by the initial value of the variant f (i.e., modulo p) to generate the variant y′, as shown in Equation (6). Appropriate mapping relationship between the variant f and the variant g and the variant set (l₁, l₂, l₃, l₄) may reduce the number of possible

$$⌊ \frac{{y}_{t}}{p} ⌋ .$$

Therefore, the modulo divider 82 may also be replaced by a simple comparator.

$$\begin{matrix}{y}_{t} = \frac{{l}_{3} x + {l}_{4} y + ( - ( {l}_{3} x + {l}_{4} y ) mod {2}^{m} ) p}{{2}^{m}} & Equation ( 5 ) \\ {y}^{′} = {y}_{t} - ⌊ \frac{{y}_{t}}{p} ⌋ p & Equation ( 6 )\end{matrix}$$

The switching circuit 92 may receive an instruction including a variant f and a variant g′ from the switching circuit 91. The switching circuit 92 may respectively receive the variant x′ and the variant y′ from the modulo divider 81 and the modulo divider 82. Then, the switching circuit 92 may update the variant x in the register 23 according to one of the variant x′ and the variant y′, and update the variant y in the register 24 according to the other one of the variant x′ and the variant y′. Specifically, the switching circuit 92 may compare the variant f and the variant g′. If f≥g′, the switching circuit 92 may transmit the variant x′ to the multiplexer 13. The processor 110 may control the multiplexer 13 to transmit the variant x′ to the register 23 to update the variant x in the register 23. In addition, the switching circuit 92 may transmit the variant y′ to the multiplexer 14. The processor 110 may control the multiplexer 14 to transmit the variant y′ to the register 24 to update the variant y in the register 24. If f′<g′, the switching circuit 92 may transmit the variant y′ to the multiplexer 13. The processor 110 may control the multiplexer 13 to transmit the variant y′ to the register 23 to update the variant x in the register 23. In addition, the switching circuit 92 may transmit the variant x′ to the multiplexer 14. The processor 110 may control the multiplexer 14 to transmit the variant x′ to the register 24 to update the variant y in the register 24.

After updating the variant f in the register 11, the variant g in the register 12, the variant x in the register 13, and the variant y in the register 14, the processor 110 may determine that step S207 has been finished, and execute step S203 again. If the modulo divider 100 operates in the fixed execution time mode, the processor 110 may increase the count value by one after the variant x in the register 13 is updated and before executing step S203 again.

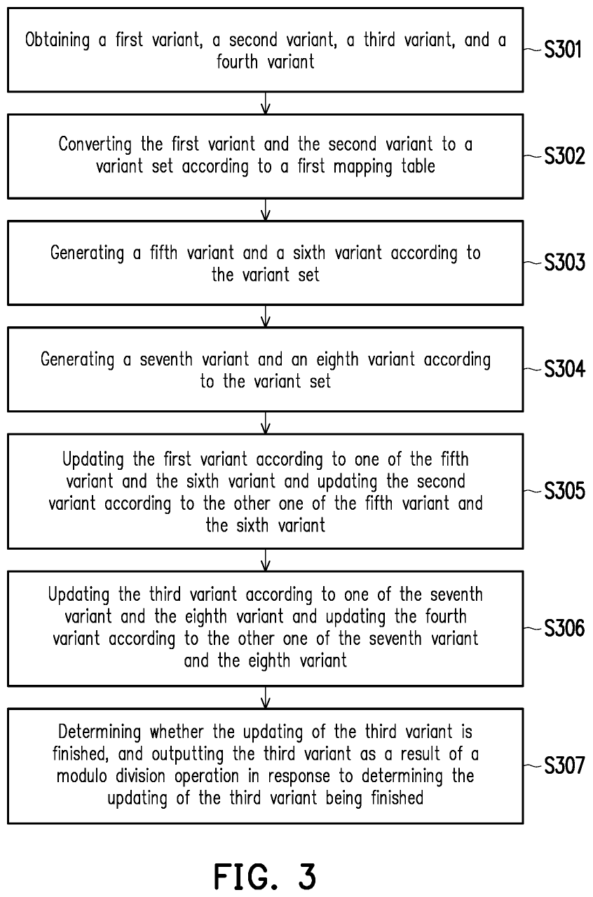

FIG. 3 is a flowchart of a modulo division operation method for binary data according to an embodiment of the disclosure, in which the modulo division operation method may be implemented by the modulo divider 100 shown in FIG. 1. In step S301, a first variant, a second variant, a third variant, and a fourth variant are obtained. In step S302, the first variant and the second variant are converted to a variant set according to the first mapping table. In step S303, a fifth variant and a sixth variant are generated according to the variant set. In step S304, a seventh variant and an eighth variant are generated according to the variant set. In step S305, the first variant is updated according to one of the fifth variant and the sixth variant, and the second variant is updated according to the other one of the fifth variant and the sixth variant. In step S306, the third variant is updated according to one of the seventh variant and the eighth variant, and the fourth variant is updated according to the other one of the seventh variant and the eighth variant. In step S307, it is determined whether the updating of the third variant is finished, and in response to determining that the updating of the third variant is finished, the third variant is output as a result of the modulo division operation.

Table 2 compares the performance of the modulo division operation architecture of this disclosure with other modulo division operation architectures, where Literature [0] is the modulo division operation architecture provided in this disclosure. Table 2 shows that the modulo division operation architecture of the disclosure outperforms other modulo division operation architectures in terms of execution speed and security. Since the modulo division operation may be regarded as a combination of the modulo reciprocation and the modulo multiplication, the Literature [1], [3], and [4] choose to realize the modulo reciprocation, while the Literature [2] and [5] choose to realize the modulo division. Literature [1] uses a variation of the binary greatest common divisor algorithm (binary GCD) as documented in Literature [6], omitting the intermediate process of register value swapping and bit difference (δ) recording. Each iteration reduces the number of bits by a certain amount, taking an average of 496 clock cycles to finish the reciprocation of 256 bits. Literature [2] also adopts the binary greatest common divisor algorithm, omitting the intermediate process of register value swapping and bit difference (δ) recording, while increase the number of comparison procedures and the amount of shifts to increase the number of bits reduced by each iteration. The 256-bit modulo division operation takes an average of 169 clock cycles to finish. The algorithm and iterative process used in Literature [3] are basically the same as Literature [1], but Literature [3] reduces the control procedure and hardware in the iterative process, such that it takes an average of 341 clock cycles to finish the reciprocation of 256 bits. Compared with Literature [2], Literature [4] adds more shifts, and reduces some comparison conditions to reduce hardware complexity, but its average number of iterations is not as good as Literature [2]. Literature [4] takes an average of 320 clock cycles to finish the 256-bit modulo reciprocation. Literature [5] uses an algorithm similar to Literature [1] and Literature [3], but it changes the order of shifts in the hardware architecture, such that its hardware performance is much better than Literature [1] and Literature [3]. In addition, Literature [5] may ensure that the execution time of the modulo division operation is a fixed value, for example, the 256-bit modulo division operation may be finished within 512 clock cycles. Under the architecture of this disclosure, the 256-bit modulo division operation may be finished within 512/m iterations. In addition, in order to shorten the critical path length, the disclosure adopts a pipeline design, so that the operation may be finished within (512/m+1) clock cycles. Furthermore, the modulo divider of the disclosure may support a non-fixed execution time mode, and may finish a 256-bit modulo division operation within 180 clock cycles on average.

TABLE 2

| | | Maximum/ | | Area/ | Normalized |
|---|---|---|---|---|---|
| | Operating | Average | Frequency | Number of | area (mm²)/ |
| Literature | platform | Clock cycle | MHz | slices | Time(sec) |
| [0] | ASIC(40- | 257/180 | 300 | 0.598(mm²) | 0.9/0.63 |
| | nm)(m = 2) | | | | |
| [1] | Virtex- | —/496 | 34 | 9146(slices) | —/73.4 |
| | II(FPGA, 150- | | | | |
| | nm PL) | | | | |
| [2] | Virtex- | —/169 | 37 | 9213(slices) | —/25.2 |
| | II(FPGA, 150- | | | | |
| | nm PL) | | | | |
| [3] | Virtex- | —/341 | 146 | 1480(slices) | —/1.89 |
| | 7(FPGA, 28- | | | | |
| | nm PL) | | | | |
| [4] | Virtex- | —/320 | 144 | 617(slices) | —/0.75 |
| | 7(FPGA, 28- | | | | |
| | nm PL) | | | | |
| [5] | Virtex- | 512/— | 550 | 645(slices) | 1/— |
| | 7(FPGA, 28- | | | | |
| | nm PL) | | | | |
| [6] | ASIC(40-nm) | 512/— | 550 | 0.0546(mm²) | 1/— |

[1]: S. Ghosh, D. Mukhopadhyay, and D. Roychowdhury, “Petrel: Power and Timing Attack Resistant Elliptic Curve Scalar Multiplier Based on Programmable GF_p Arithmetic Unit,” IEEE Transactions on Circuits and Systems I: Regular Papers, vol. 58, no. 8, pp. 1798-1812, 2011, doi: 10.1109/tcsi.2010.2103190.
[2]: J. -W. Lee, S. -C. Chung, H. -C. Chang, and C. -Y. Lee, “Efficient Power-Analysis-Resistant Dual-Field Elliptic Curve Cryptographic Processor Using Heterogeneous Dual-Processing-Element Architecture,” IEEE Transactions on Very Large Scale Integration (VLSI) Systems, vol. 22, no. 1, pp. 49-61, 2014, doi: 10.1109/tvlsi.2013.2237930.
[3]: M. S. Hossain and Y. Kong, “High-Performance FPGA Implementation of Modular Inversion over F_256 for Elliptic Curve Cryptography,” 2015: IEEE International Conference on Data Science and Data Intensive Systems, doi: 10.1109/dsdis.2015.47.
[4]: X. Dong, L. Zhang, and X. Gao, “An Efficient FPGA Implementation of ECC Modular Inversion over F256,” 2018: ACM, doi: 10.1145/3199478.3199491.
[5]: T. Kudithi and S. R, “An efficient hardware implementation of the elliptic curve cryptographic processor over prime field,” International Journal of Circuit Theory and Applications, vol. 48, no. 8, pp. 1256-1273, 2020, doi: 10.1002/cta.2759.
[6]: M. E. Kaihara and N. Takagi, “A Hardware Algorithm for Modular Multiplication/Division,” IEEE Transactions on Computers, vol. 54, no. 01, pp. 12-21, 2005, doi: 10.1109/tc.2005.1.

This disclosure realizes the modulo division operation in the Ed25519 digital signature system based on the binary greatest common divisor algorithm. The disclosure may increase the operation speed of the modulo division operation. The 256-bit modulo division operation is finished in 512/m iterations. The disclosure adopts a pipeline design, so that the modulo division operation may be finished within 512/(m+1) clock cycles. In a fixed execution time mode, the modulo divider only needs to execute an average of 180 iterations to finish the modulo division operation. In addition, the disclosure significantly reduces the hardware complexity of the modulo divider through the design of the number pair mapping relationship.

To sum up, this disclosure implements a modulo division method that may be used in the Ed25519 digital signature system based on the Montgomery algorithm. This disclosure reduces the number of clock cycles required for modulo division operations through the design of the number pair mapping relationship, the pipelined updating sequence, and the fast operation properties of the lookup table. The disclosure may reduce the critical path length of the modulo divider, increase the operation efficiency, and support two modes such as the fixed execution time mode and the non-fixed execution time mode.

What is claimed is:

1. A modulo divider for binary data, comprising:
a first register, storing a first variant;
a second register, storing a second variant;
a third register, storing a third variant;
a fourth register, storing a fourth variant;
a first logic mapping circuit, coupled to the first register and the second register, and converting the first variant and the second variant to a variant set according to a first mapping table;
a second logic mapping circuit, coupled to the first logic mapping circuit, and obtaining the variant set based on a first instruction from the first logic mapping circuit;
a first calculation circuit, coupled to the first logic mapping circuit, and generating a fifth variant and a sixth variant according to the variant set
a second calculation circuit, coupled to the second logic mapping circuit, and generating a seventh variant and an eighth variant according to the variant set;
a first switching circuit, coupled to the first calculation circuit, the first register, and the second register, wherein the first switching circuit updates the first variant according to one of the fifth variant and the sixth variant, and updates the second variant according to another one of the fifth variant and the sixth variant;
a second switching circuit, coupled to the second calculation circuit, the third register, the fourth register, and the first switching circuit, wherein the second switching circuit updates the third variant according to one of the seventh variant and the eighth variant based on a second instruction from the first switching circuit, and updates the fourth variant according to another one of the seventh variant and the eighth variant; and
a processor, coupled to the second register, wherein the processor determines whether an updating of the third variant is finished, and outputs the third variant as a result of the modulo division operation in response to determining the updating of the third variant is finished.

2. The modulo divider according to claim 1, wherein the first calculation circuit comprises:
a first multiplier, coupled to the first register and the first logic mapping circuit, and outputting a first product of the first variant and a first value in the variant set;
a second multiplier, coupled to the second register and the first logic mapping circuit, and outputting a second product of the second variant and a second value in the variant set;
a first adder, coupled to the first multiplier and the second multiplier, and calculating a first sum of the first product and the second product; and
a first shifter, coupled to the first adder and the first switching circuit, and shifting the first sum to generate the fifth variant.

3. The modulo divider according to claim 2, wherein the first calculation circuit further comprises:
a third multiplier, coupled to the first register and the first logic mapping circuit, and outputting a third product of the first variant and a third value in the variant set;
a fourth multiplier, coupled to the second register and the first logic mapping circuit, and outputting a fourth product of the second variant and a fourth value in the variant set;
a second adder, coupled to the third multiplier and the fourth multiplier, and calculating a second sum of the third product and the fourth product; and
a second shifter, coupled to the second adder and the first switching circuit, and shifting the second sum to generate the sixth variant.

4. The modulo divider according to claim 1, wherein the first mapping table comprises a mapping relationship between the first variant, the second variant, and the variant set, wherein the mapping relationship satisfies following conditions:
$$\{ \begin{matrix}( {l}_{1} f + {l}_{2} g ) mod {2}^{m} = 0 \\ ( {l}_{3} f + {l}_{4} g ) mod {2}^{m} = 0 \\ {l}_{1} f + {l}_{2} g > 0 \\ {l}_{3} f + {l}_{4} g > 0 \\ {l}_{1} {l}_{4} - {l}_{2} {l}_{3} = \pm {2}^{m} \\ \frac{( {l}_{1} f + {l}_{2} g ) \times ( {l}_{3} f + {l}_{4} g )}{{2}^{{2}^{m}}} \leq \frac{fg}{{2}^{m}}\end{matrix}$$
wherein f is the first variant, g is the second variant, l₁ is a first value in the variant set, l₂ is a second value in the variant set, l₃ is a third value in the variant set, l₄ is a fourth value in the variant set, and m is a positive integer.

5. The modulo divider according to claim 1, wherein the second calculation circuit comprises:
a fifth multiplier, coupled to the third register and the second logic mapping circuit, and outputting a fifth product of the third variant and a first value in the variant set;
a sixth multiplier, coupled to the fourth register and the second logic mapping circuit, and outputting a sixth product of the fourth variant and a second value in the variant set;
a third adder, coupled to the fifth multiplier and the sixth multiplier, and calculating a third sum of the fifth product and the sixth product a third shifter, coupled to the third adder and shifting the third sum;
a lookup table circuit, coupled to the third adder, and generating a first lookup value corresponding to the third sum according to the lookup table;
a fourth adder, coupled to the third shifter and the lookup table circuit, and calculating a fourth sum of the third sum that has been shifted and the first lookup value; and
a first modulo divider, coupled to the fourth adder, and modulo-dividing the fourth sum by an initial value of the first variant to generate the seventh variant.

6. The modulo divider according to claim 5, wherein the second calculation circuit further comprises:
a seventh multiplier, coupled to the third register and the second logic mapping circuit, and outputting a seventh product of the third variant and a third value in the variant set;
an eighth multiplier, coupled to the fourth register and the second logic mapping circuit, and outputting an eighth product of the fourth variant and a fourth value in the variant set;
a fifth adder, coupled to the seventh multiplier, the eighth multiplier, and the lookup table circuit, and calculating a fifth sum of the seventh product and the eighth product, wherein the lookup table circuit generates a second lookup value corresponding to the fifth sum according to the lookup table;
a fourth shifter, coupled to the fifth adder, and shifting the fifth sum;
a sixth adder, coupled to the fourth shifter and the lookup table circuit, and calculating a sixth sum of the fifth sum that has been shifted and the second lookup value; and
a second modulo divider, coupled to the sixth adder, and modulo-dividing the sixth sum by the initial value of the first variant to generate the eighth variant.

7. The modulo divider according to claim 1, wherein
in response to the fifth variant being greater than or equal to the sixth variant, the first switching circuit updates the first variant according to the fifth variant and updates the second variant according to the sixth variant.

8. The modulo divider according to claim 1, wherein
in response to the fifth variant being less than the sixth variant, the first switching circuit updates the first variant according to the sixth variant and updates the second variant according to the fifth variant.

9. The modulo divider according to claim 1, wherein
in response to the fifth variant being greater than or equal to the sixth variant, the second switching circuit updates the third variant according to the seventh variant and updates the fourth variant according to the eighth variant.

10. The modulo divider according to claim 1, wherein
in response to the fifth variant being less than the sixth variant, the second switching circuit updates the third variant according to the eighth variant and updates the fourth variant according to the seventh variant.

11. The modulo divider according to claim 5, wherein the third sum and the first lookup value satisfy following conditions:
$${LT}_{out} = [ ( - {LT}_{in} \times {p}^{- 1} mod {2}^{m} ) \times p + {LT}_{in} ] >> m$$
wherein LTₒᵤₜ is the first lookup value, LTᵢₙ is the third sum, p is the initial value of the first variant, m is a positive integer, and >>m means shifting m bits to the right.

12. The modulo divider according to claim 1, wherein the processor is configured to execute:
in response to the third variant being updated, increasing a count value; and
in response to the count value reaching a target value, determining the updating of the third variant is finished, wherein the target value is associated with a number of bits of the third variant.

13. The modulo divider according to claim 1, wherein the processor is configured to execute:
in response to the second variant being updated to zero, determining the updating of the third variant is finished.

14. The modulo divider according to claim 1, wherein the modulo of the modulo division operation is an initial value of the first variant, wherein a dividend of the modulo division operation is equal to dividing an initial value of the fourth variant by an initial value of the second variant.

15. The modulo divider according to claim 14, wherein the initial value of the fourth variant and the initial value of the second variant are coprime.

16. A modulo division operation method for binary data, comprising:
obtaining a first variant, a second variant, a third variant, and a fourth variant;
converting the first variant and the second variant to a variant set according to a first mapping table;
generating a fifth variant and a sixth variant according to the variant set;
generating a seventh variant and an eighth variant according to the variant set;
updating the first variant according to one of the fifth variant and the sixth variant, and updating the second variant according to another one of the fifth variant and the sixth variant;
updating the third variant according to one of the seventh variant and the eighth variant, and updating the fourth variant according to another one of the seventh variant and the eighth variant; and
determining whether an updating of the third variant is finished, and outputting the third variant as a result of the modulo division operation in response to determining the updating of the third variant is finished.
